(19) United States
(12) Patent Application Publication
(10) Pub. No.: US 2025/0326270 A1
(43) Pub. Date: Oct. 23, 2025

(54) APPARATUS AND METHOD FOR CONTROLLING AIR CONDITIONING USING LIDAR

(71) Applicants: HYUNDAI MOTOR COMPANY, Seoul (KR); KIA CORPORATION, Seoul (KR)

(72) Inventors: Kwang Ok HAN, Seoul (KR); Myung Hoe KIM, Seoul (KR); Hyo Geun OH, Cheongju-si (KR); Su Yeon KANG, Seoul (KR); Kwang Woon CHO, Yongin-si (KR)

(21) Appl. No.: 18/827,587

(22) Filed: Sep. 6, 2024

(30) Foreign Application Priority Data
Apr. 22, 2024 (KR) 10-2024-0053402

(51) Int. Cl. B60H 1/00

(52) U.S. Cl. CPC B60H 1/00742; B60H 1/00764; B60H 1/00964

(57) ABSTRACT

An apparatus for controlling air conditioning using LiDAR includes a state determination unit configured to determine whether a passenger counting condition is satisfied, a passenger counting unit configured to determine, based on LiDAR information received from the LiDAR device, boarding and alighting of a person with respect to the transportation means, to count the number of passengers, and to output a count value, when the passenger counting condition is satisfied, a correction unit configured to correct, based on the count value, a target control value in response to the number of passengers, and to output a target correction control value, and a control unit configured to control, based on the target correction control value, the air conditioning system.

### CROSS-REFERENCE TO RELATED APPLICATION

This application claims benefit of priority to Korean Patent Application No. 10-2024-0053402, filed on Apr. 22, 2024, in the Korean Intellectual Property Office, the disclosure of which is incorporated herein by reference in its entirety.

### TECHNICAL FIELD

The present disclosure relates to an apparatus and method for controlling air conditioning using a light detection and ranging (LiDAR) applicable to a transportation means such as a vehicle or the like.

### BACKGROUND

A transportation means such as a vehicle may include an air conditioning system controlling, based on an indoor air state such as temperature and humidity, air conditioning systems such as blowers, temperature control doors, and intake doors to control the indoor air state.

Air conditioning control methods may control an air conditioning system in response to a detected temperature. In some cases, air conditioning control methods may control an air conditioning system based on the number of passengers in a transportation means. In some cases, the methods may detect the number of passengers in the transportation means.

For example, an air conditioning control apparatus may use seat belt sensors, seat weight scales, door opening sensors, or facial recognition cameras to sense the number of passengers.

In some cases, where a physical sensor is used as described above to sense the number of passengers, everyone, including people who are standing instead of sitting on the seat, may not be sensed. In some cases, where a facial recognition camera is used, people who are not looking at the camera may not be sensed.

As described passengers may not be accurately sensed.

### SUMMARY

The present disclosure describes an apparatus and method for controlling air conditioning using a LiDAR, the apparatus and method capable of accurately sensing the number of passengers using the LiDAR, and accurately reflecting the number of passengers in a load condition of an air conditioning system, thereby efficiently controlling the air conditioning system.

According to an aspect of the present disclosure, there is provided an apparatus for controlling air conditioning using LiDAR, the apparatus including a state determination unit configured to determine, based on an operating state, a speed, and a door state of a transportation means, equipped with a LiDAR device and an air conditioning system, and an operation mode of the air conditioning system, whether a passenger counting condition is satisfied, a passenger counting unit configured to determine, based on LiDAR information received from the LiDAR device, boarding and alighting of a person with respect to the transportation means, to count the number of passengers, and to output a count value, when the passenger counting condition is satisfied, a correction unit configured to correct, based on the count value, a target control value in response to the number of passengers, and to output a target correction control value, and a control unit configured to control, based on the target correction control value, the air conditioning system.

The state determination unit is configured to determine that the passenger counting condition is satisfied, when a condition in which the transportation means is in an operation-on state, a condition in which the air conditioning system is in an automatic mode, a condition in which a speed of the transportation means is less than or equal to a reference speed, and a condition in which a door of the transportation means is in an open state are all met.

The passenger counting unit may include a human determination unit configured to determine, based on the LiDAR information, whether an object, entering and exiting a preset range of the transportation means, is a human, a boarding/alighting determination unit configured to recognize boarding when a person, entering the preset range of the transportation means, moves closer to the transportation means, and to recognize alighting when a person, exiting the preset range of the transportation means, moves away from the transportation means, when the object, entering and exiting the preset range of the vehicle, is a human, and a passenger number calculation unit configured to increase the number of passengers when the boarding/alighting determination unit recognizes boarding, and to decrease the number of passengers when the boarding/alighting determination unit recognizes alighting.

The correction unit may include a control value memory configured to store a predetermined target control value, and a control value correction unit configured to calculate a weight using the number of passengers, based on the count value, and the target control value, to correct the target control value using the weight, and to output the target correction control value.

The control value correction unit may include a passenger number increase/decrease determination unit configured to determine, based on the number of passengers, an increase or decrease in the number of passengers, a first correction unit configured to calculate the target correction control value by applying, in response to an increase in the number of passengers, a positive (+) weight to the target control value, and a second correction unit configured to calculate the target correction control value by applying, in response to a decrease in the number of passengers, a negative (−) weight to the target control value.

The control value correction unit may be configured to reflect, in the weight, at least one of pieces of additional information on a person entering and exiting the preset range, included in the LiDAR information, when the target control value is corrected.

The correction unit may be configured to determine, in response to an increase or decrease in the number of passengers, the weight at an application ratio according to a preset correction function. The correction function may be at least one of a linear function and a nonlinear function.

The correction function of the correction unit may be applied up to a preset upper limit number of passengers, and may be configured to maintain a weight, corresponding to the upper limit number of passengers, when the number of passengers is greater than the upper limit number of passengers.

With respect to preset target air conditioning devices among air conditioning devices included in the air conditioning system, the correction unit may be configured to calculate target correction control values for the target air conditioning devices by applying, in response to an operating state of each of the target air conditioning devices, the weight differently to different target control values for the target air conditioning devices.

The control unit may include an operation mode memory configured to store an automatic mode target correction control value for each detected temperature for an automatic mode of the air conditioning system, and to store a preset manual mode target control value for a manual mode of the air conditioning system, and a controller configured to control, in response to a detected temperature, the air conditioning system using the automatic mode target correction control value for each detected temperature stored in the memory, when the air conditioning system is in the automatic mode.

According to another aspect of the present disclosure, there is provided a method for controlling air conditioning using a LiDAR, the method including a state determination operation of determining, based on an operating state, a speed, and a door state of a transportation means, equipped with a LiDAR device and an air conditioning system, and an operation mode of the air conditioning system, whether a passenger counting condition is satisfied, a passenger counting operation of determining, based on LiDAR information received from the LiDAR device, boarding and alighting of a person with respect to the transportation means, counting the number of passengers, and outputting a count value, when the passenger counting condition is satisfied, a control value correction operation of correcting, based on the count value, a target control value in response to the number of passengers, and outputting a target correction control value, and an air conditioning control operation of controlling, based on the target correction control value, the air conditioning system.

The state determination operation may include determining that the passenger counting condition is satisfied, when a condition in which the transportation means is in an operation-on state, a condition in which the air conditioning system is in an automatic mode, a condition in which a speed of the transportation means is less than or equal to a reference speed, and a condition in which a door of the transportation means is in an open state are all met.

The passenger counting operation may include a human determination operation of determining, based on the LIDAR information, whether an object, entering and exiting a preset range of the transportation means, is a human, a boarding/alighting determination operation of recognizing boarding when a person, entering the preset range of the transportation means, moves closer to the transportation means, and recognizing alighting when a person, exiting the preset range of the transportation means, moves away from the transportation means, when the object, entering and exiting the preset range of the vehicle, is a human, and a passenger number calculation operation of increasing the number of passengers when boarding is recognized in the boarding/alighting determination operation, and decreasing the number of passengers when alighting is recognized in the boarding/alighting determination operation.

The control value correction operation may include calculating a weight using the number of passengers, based on the count value, and the target control value, correcting the target control value using the weight, and outputting the target correction control value.

The control value correction operation may include a passenger number increase/decrease determination operation of determining, based on the number of p passengers, an increase or decrease in the number of passengers, a first correction operation of calculating the target correction control value by applying, in response to an increase in the number of passengers, a positive (+) weight to the target control value, and a second correction operation of calculating the target correction control value by applying, in response to a decrease in the number of passengers, a negative (−) weight to the target control value.

The control value correction operation may include reflecting, in the weight, at least one of pieces of additional information on a person entering and exiting the preset range, included in the LiDAR information, when the target control value is corrected.

The control value correction operation may include determining, in response to an increase or decrease in the number of passengers, the weight at an application ratio according to a preset correction function. The correction function may be at least one of a linear function and a nonlinear function.

The correction function of the control value correction operation may be applied up to a preset upper limit number of passengers, and may be configured to maintain a weight, corresponding to the upper limit number of passengers, when the number of passengers is greater than the upper limit number of passengers.

With respect to preset target air conditioning devices among air conditioning devices included in the air conditioning system, the control value correction operation may include calculating target correction control values for the target air conditioning devices by applying, in response to an operating state of each of the target air conditioning devices, the weight differently to different target control values for the target air conditioning devices.

The control value correction operation may include controlling termination of the air conditioning system by initializing a weight changed in response to a change in the number of passengers.

In addition, the aspects of the present disclosure are not limited to those set forth herein, and other aspects may be additionally understood in the course of describing example implementations below.

In some implementations, the number of passengers may be accurately sensed using a LiDAR sensor, and the sensed number of passengers may be more accurately reflected in a load condition of an air conditioning system, thereby efficiently controlling the air conditioning system.

In some implementations, an amount of operation of the air conditioning system may be controlled based on the accurately sensed number of passengers, and accordingly preemptive air conditioning control may be performed, as compared to a temperature control method according to the related art, thereby providing comfort and a power cost savings effect.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic diagram of an air conditioning control apparatus.

FIG. 2 is an example diagram of an air conditioning control apparatus.

FIG. 3 is an example diagram of a state determination unit.

FIG. 4 is an example diagram of a passenger counting unit.

FIG. 5 is a diagram illustrating operation of a LiDAR sensor unit and a passenger counting unit.

FIG. 6 is an example diagram of a correction unit.

FIG. 7 is an example diagram of a control value correction unit.

FIG. 8 is an example diagram of a control value correction unit.

FIG. 9A is an example diagram of a linear curve of a linear function for determining an application ratio to a weight of a correction unit, and FIG. 9B is an example diagram of a nonlinear curve of a nonlinear function for determining an application ratio of a weight of a correction unit.

FIG. 10A is an explanatory diagram of a target correction control value according to a weight for an indoor/outdoor air volume controller, FIG. 10B is an explanatory diagram of a target correction control value according to a weight for a temperature control door, and FIG. 10C is an explanatory diagram of a target correction control value according to a weight for a blower control door.

FIG. 11 is an example diagram of a control unit.

FIG. 12 is a flowchart of an air conditioning control method.

FIG. 13 is an example diagram of a state determination operation.

FIG. 14 is an example diagram of a passenger counting operation.

FIG. 15 is an example diagram of a control value correction operation using a weight.

FIG. 16 is an example diagram of a control value correction operation in which a weight is applied differently in response to an increase or decrease of the number of passengers.

FIG. 17 is an example diagram of a control value correction operation using additional information.

FIG. 18 is a block diagram of a computer device capable of fully or partially implementing an apparatus and method for controlling air conditioning.

### DETAILED DESCRIPTION

Hereinafter, specific example implementations of the present disclosure will be described with reference to the accompanying drawings. The following detailed description is provided to aid in a comprehensive understanding of a method, a device and/or a system described in the present specification. However, the detailed description is for illustrative purposes only, and the present disclosure is not limited thereto.

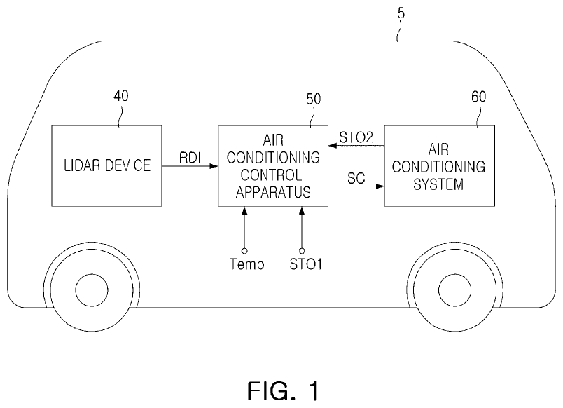

FIG. 1 is a schematic diagram of an air conditioning control apparatus.

In some implementations, referring to FIG. 1, an air conditioning control apparatus 50 may be mounted on a transportation means 5, together with a LiDAR device 40 and an air conditioning system 60.

The LiDAR device 40 may measure distance using a laser, may recognize a surrounding object (OBT), and may provide information on whether the recognized object (OBT) is a human, information on a speed and a direction of the recognized object, and LiDAR information (RDI) including information on a distance from the recognized object.

The transportation means 5 may include various sensors, including a temperature sensor, and an electronic control unit (ECU) comprehensively controlling an overall operation of the transportation means 5, and the ECU may provide, to the air conditioning control apparatus 50, a state signal (STO1) including information on an operation-on state of the transportation means 5 and information on an open state of a door, and a detected temperature (Temp).

The air conditioning system 60 may provide a state signal (STO2) including automatic mode information to the air conditioning control apparatus 50.

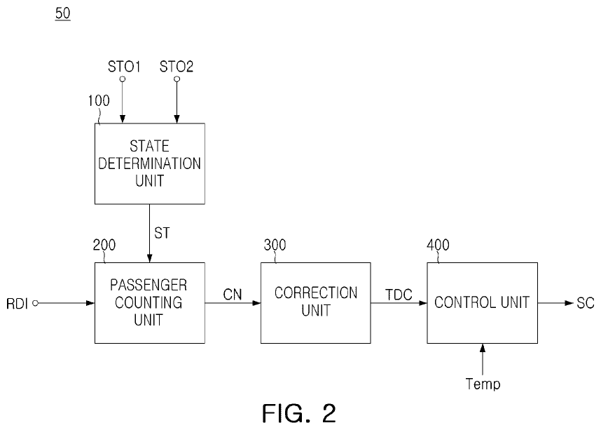

The air conditioning control apparatus 50 may identify, based on LiDAR information (RDI) received from the LiDAR device 40, the state (STO1) signal of the transportation means 5, the detected temperature Temp, and the state signal (STO2) received from the air conditioning system 60, the number of passengers, may correct, based on the identified number of passengers, a target control value, and may control, the air conditioning system 60 using a control signal (SC) based on a target correction control value obtained by correcting the target control value, which will be described with reference to FIGS. 2 to 11.

With respect to drawings of the present disclosure, unnecessary repeated descriptions of components having the same reference numeral and the same function may be omitted, and possible differences between the drawings may be described.

FIG. 2 is an example diagram of an air conditioning control apparatus.

Referring to FIG. 2, the air conditioning control apparatus 50 may include a state determination unit 100, a passenger counting unit 200, a correction unit 300, and a control unit 400.

The state determination unit 100 may determine, based on an operating state, a speed, and a door state of the transportation means 5, equipped with the LiDAR device 40 and the air conditioning system 60, and an operation mode of the air conditioning system 60, whether a passenger counting condition is satisfied, and may output a trigger signal (ST) for starting a counting operation, when the passenger counting condition is satisfied.

The passenger counting unit 200 may determine, based on LiDAR information (RDI) received from the LiDAR device 40, boarding and alighting of a person with respect to the transportation means 5, may count the number of passengers (N), and may output a count value (CN) including information on the number of passengers (N), when the passenger counting condition is satisfied.

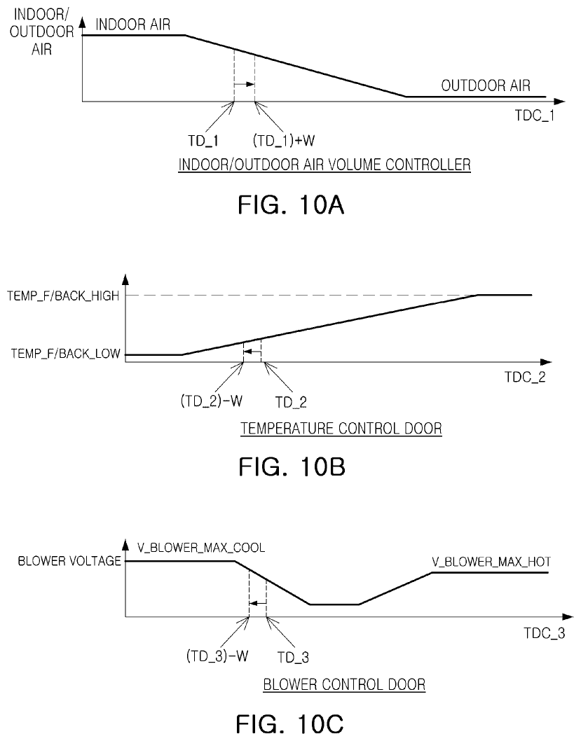

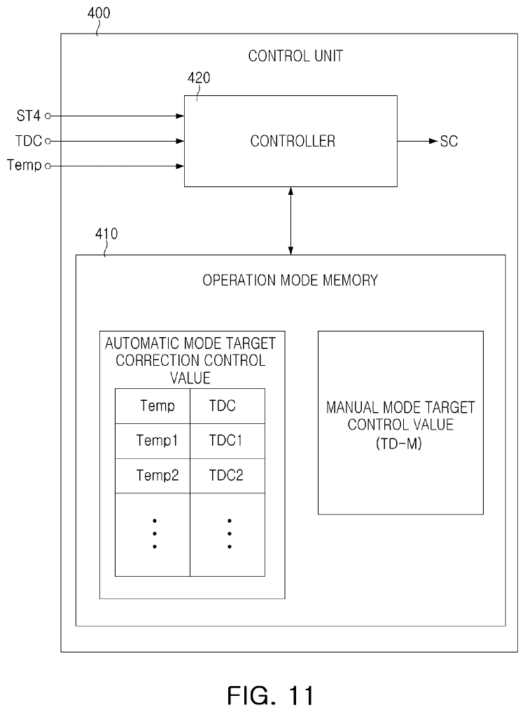

The correction unit 300 may correct, based on the count value (CN), a predetermined target control value (TD) in response to the number of passengers (N), and may output a target correction control value (TDC) to the control unit 400. As an example, the correction unit 300 may correct, based on the number of passengers (N), target control values (for example, TD1, TD2, . . . , see FIG. 10) respectively corresponding to a plurality of air conditioning devices included in the air conditioning system 60, and may output, to the control unit 400, target correction control values (for example, TDC1, TDC2, . . . , see FIGS. 10 and 11).

In addition, the control unit 400 may control, based on the target correction control value (TDC) received from the correction unit 300, the air conditioning system 60. For example, in the air conditioning system 60, in the present disclosure, a control target may be an indoor/outdoor air volume controller, a temperature control door, or a blower control door, as illustrated in FIGS. 10A, 10B, and 10C, but the present disclosure is not limited thereto.

In the present disclosure, the state determination unit 100, the passenger counting unit 200, the correction unit 300, and the control unit 400 may be implemented as separate processors, or the state determination unit 100, the passenger counting unit 200, the correction unit 300, and the control unit 400 may be implemented with a single processor, but the present disclosure is not limited thereto.

In addition, the state determination unit 100, the passenger counting unit 200, the correction unit 300, and the control unit 400 may be implemented as hardware or software, or a combination thereof, on at least one integrated circuit (IC) embedded in the air conditioning control apparatus 50, but the present disclosure is not limited thereto.

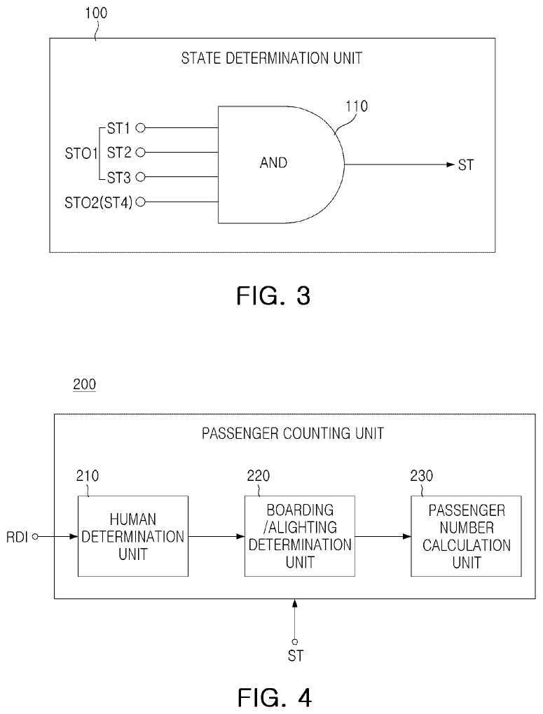

FIG. 3 is an example diagram of a state determination unit.

Referring to FIG. 3, the state determination unit 100 may determine that the passenger counting condition is satisfied, when a condition in which the transportation means 5 is in an operation-on state, a condition in which the air conditioning system 60 is in an automatic mode, a condition in which a speed of the transportation means 5 is less than or equal to a reference speed, and a condition in which a door of the transportation means 5 is in an open state are all met.

For example, the state determination unit 100 may include an AND gate 110, and the AND gate 110 may perform a logical product operation on a state signal (ST1) having a high (H) level in a condition in which the transportation means 5 is in an operation-on state, a state signal (ST2) having a high (H) level in a condition in which a speed of the transportation means 5 is less than or equal to a reference speed, and a state signal (ST3) having a high (H) level in a condition in which a door of the transportation means 5 is in an open state, and a state signal (ST4) having a high (H) level in a condition in which the air conditioning system 60 is in an automatic mode to output a trigger signal (ST) having a high (H) level when all of the four state signals (ST1, ST2, ST3, and ST4) have a high (H) level, for example.

For example, the reference speed of the transportation means 5 may be set differently depending on a type and characteristics of the transportation means, such as a passenger car, a bus, a subway, or the like, in consideration of various factors such as safety of a passenger, a situation of boarding and alighting, accuracy of sensing boarding and alighting, and the like.

In the present disclosure, each of a high (H) level and a low (L) level may be logic 1 or logic 0, and the high level and low level may be a voltage level, but the present disclosure is limited thereto. In the above example, a case in which the air conditioning control apparatus 50 is “active high” is described, but the case is only an example for ease of description and understanding, and thus present disclosure is not limited thereto. Accordingly, the present disclosure may be applied to a case in which the air conditioning control apparatus 50 is “active low” is described, which may be applied to the following description.

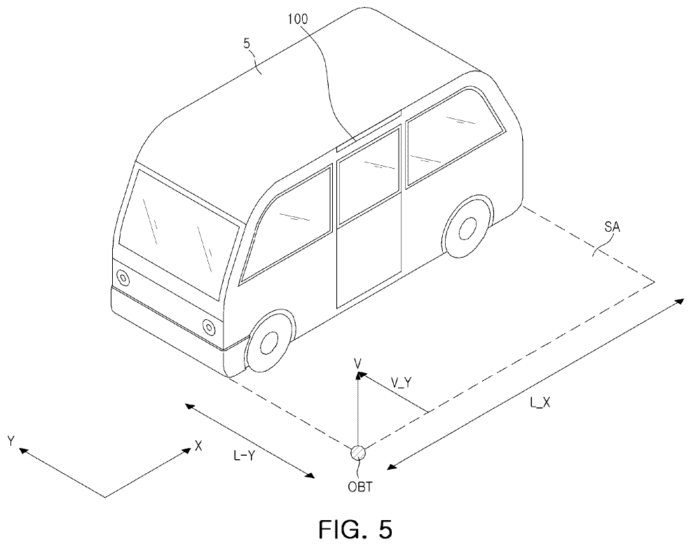

FIG. 4 is an example diagram of a passenger counting unit. FIG. 5 is a diagram illustrating operation of a LiDAR sensor unit and a passenger counting unit.

Referring to FIGS. 4 and 5, the passenger counting unit 200 may include a human determination unit 210, a boarding/alighting determination unit 220, and a passenger number calculation unit 230.

The human determination unit 210 may determine, based on the LiDAR information (RDI), whether an object, entering and exiting a preset range (SA) of the transportation means 5, is a human. For example, referring to FIG. 5, when a sensor of the LiDAR device 40 is installed at an upper end of a door of the transportation means 5, in plane coordinates determined by a X-axis (a longitudinal direction of the transportation means 5) and a Y-axis (a width direction of the transportation means 5) with respect to the door, the LiDAR device 40 may recognize, whether an object (OBT), entering and exiting the preset range (SA), is a human, a direction and a speed of movement of the object (OBT), and a distance from the object (OBT), and may provide the LiDAR information (RDI) including the recognized information to the control unit 400.

In the above example, a case in which the LiDAR device 40 is installed at the upper end of the door of the transportation means 5 is described, but the case is described only for ease of description and understanding, and the sensor of the LiDAR device 40 may be installed in various positions in accordance with an application environment, in consideration of an arrangement purpose, a use, or the like of a transportation means, such as being installed on a roof of the transformation means, on the inside of a car ceiling, or the like, and thus the present disclosure is not limited to the above example.

When the object, entering and exiting the preset range (SA) of the transportation means 5, is a human, the boarding/alighting determination unit 220 may recognize boarding when a person, entering a preset range of the transportation means 5, moves closer to the transportation means 5, and may recognize alighting when a person, exiting the preset range of the transportation means 5, moves away from the transportation means 5. For example, when the object (OBT) is a human, the boarding/alighting determination unit 220 may recognize, based on the LiDAR information (RDI), boarding when a speed (V_Y) of movement of a person, entering the preset range (SA), toward the transportation means 5 is greater than zero (V_Y>0). In addition, when the object (OBT) is a human, the boarding/alighting determination unit 220 may recognize alighting when a speed (V_Y) of movement of a person, exiting the preset range (SA), away from the transportation means 5 is greater than zero (V_Y<0). When the boarding/alighting determination unit 220 recognizes boarding, the passenger number calculation unit 230 may increase the number of passengers by “1” (N=N+1). Conversely, when the boarding/alighting determination unit 220 recognizes alighting, the passenger number calculation unit 230 may decrease the number of passengers by “1” (N=N−1).

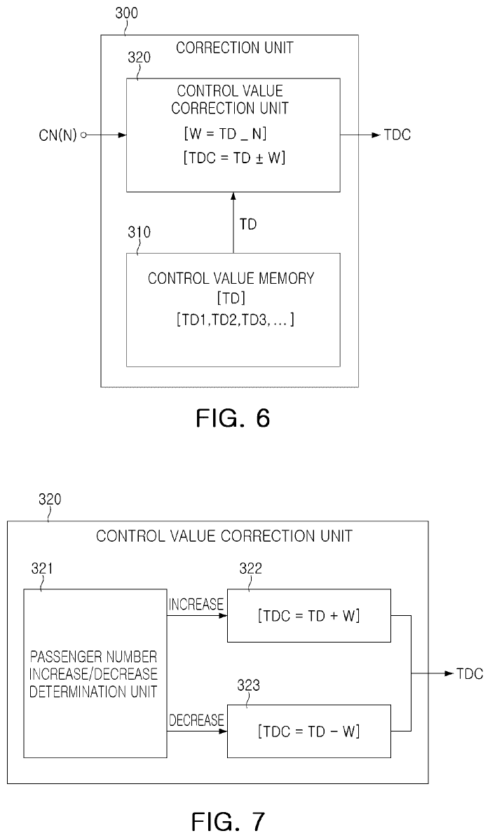

FIG. 6 is an example diagram of a correction unit.

Referring to FIG. 6, the correction unit 300 may include a control value memory 310 and a control value correction unit 320.

The control value memory 310 may store a predetermined target control value (TD). For example, the target control value (TD) may be a target control value for the air conditioning system 60. For example, when there are a plurality of target air conditioning devices to be controlled by the air conditioning system 60, the control value memory 310 may include different target control values (TD1, TD2, TD3, . . . ) for the plurality of target air conditioning devices.

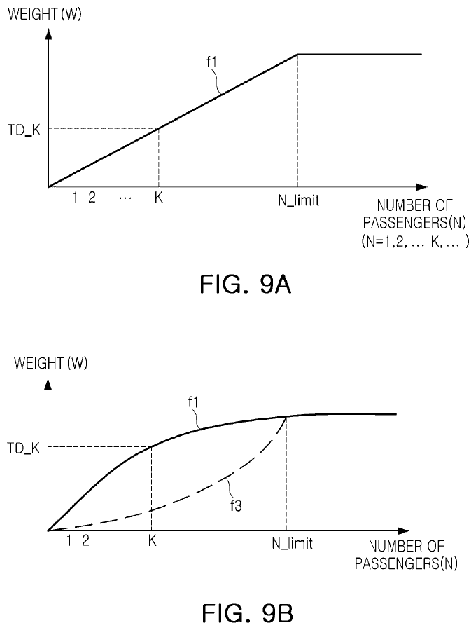

The control value correction unit 320 may calculate a weight (W=TD_N) using the number of passengers (N) based on the count value (CN) and the target control value (TD), and may correct the target control value (TD) using the weight (W) to output the target correction control value (TDC=TD±W). For example, the weight may be determined as a function of an application ratio for the target control value (TD), which will be described with reference to FIGS. 9A and 9B.

FIG. 7 is an example diagram of a control value correction unit.

Referring to FIG. 7, the control value correction unit 320 may include a passenger number increase/decrease determination unit 321, a first correction unit 322, and a second correction unit 323.

The passenger number increase/decrease determination unit 321 may determine an increase or decrease in the number of passengers. For example, the passenger number increase/decrease determination unit 321 may determine an increase or decrease in the number of passengers by comparing the previous number of passengers and the current number of passengers (N) to each other.

As the number of passengers increases, the first correction unit 322 may apply, in response to an increase in the number of passengers, a positive weight (+W) to the target control value (TD) to calculate the target correction control value (TDC=TD+W).

The second correction unit 323 may apply, in response to a decrease in the number of passengers, a negative weight (−W) to the target control value (TD) to calculate the target correction control value (TDC=TD−W).

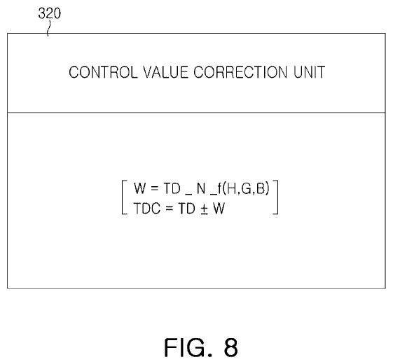

FIG. 8 is an example diagram of a control value correction unit.

Referring to FIG. 8, when the target control value (TD) is corrected, the control value correction unit 320 may reflect, in the weight (W), at least one of pieces of additional information (for example, a height (H), gender (G), and physique information (B)). For example, among the pieces of additional information, the height (H) and the physique information (B) may be compared to a reference height (H) and reference physique information (B), and a reflection ratio may be applied differently depending on a comparison result. Regarding gender (G), different reflection ratios may be applied to a man and a woman.

FIG. 9A is an example diagram of a linear curve of a linear function for determining an application ratio to a weight of a correction unit, and FIG. 9B is an example diagram of a nonlinear curve of a nonlinear function for determining an application ratio of a weight of a correction unit.

Referring to FIGS. 9A and 9B, the correction unit 300 may determine, in response to an increase or decrease in the number of passengers (N), the weight (W=TD−K) at an application ratio according to a preset correction function, and the correction function may be at least one of a linear function (f1) illustrated in FIG. 9A and a non-linear function (f2 or f3) illustrated in FIG. 9B.

In addition, the correction function of the correction unit 300 may be applied up to a preset upper limit number passengers (N_limit). When the number of passengers (N) is greater than the upper limit number of people (N_limit), a weight, corresponding to the upper limit number of passengers (N_limit), may be maintained.

FIG. 10A is an explanatory diagram of a target correction control value according to a weight for an indoor/outdoor air volume controller, FIG. 10B is an explanatory diagram of a target correction control value according to a weight for a temperature control door, and FIG. 10C is an explanatory diagram of a target correction control value according to a weight for a blower control door.

Referring to FIGS. 10A, 10B, and 10C, with respect to preset target air conditioning devices among air conditioning devices included in the air conditioning system 60, the correction unit 300 may calculate target correction control values (TDC_1, TD_2, and TD_3) for the target air conditioning devices by applying, in response to an operating state of each of the target air conditioning devices, the weight (W) differently to different target control values (TD_1, TD_2, and TD_3) for the target air conditioning devices.

For example, referring to FIG. 10A, a left side of the graph illustrated in FIG. 10A indicates a case in which an indoor air volume is selected using a high control voltage, a right side of the graph indicates a case in which an outdoor air volume is selected using a low control voltage, and a space between indoor air and outdoor air indicates a case in which the indoor air volume and the outdoor air volume are mixed using an intermediate control voltage between the high control voltage and low control voltage. In FIG. 10A, with respect to the indoor/outdoor air volume controller, when the number of passengers (N) increases, the correction unit 300 may add a weight (W) to a target control value (TD_1) of the indoor/outdoor air volume controller to obtain a target correction control value (TDC_1) of the indoor/outdoor air volume controller, such that the outdoor air volume may increase.

Referring to FIG. 10B, a left side of the graph illustrated in FIG. 10B indicates a case in which a low temperature is selected using a low control voltage (TEMP_F/BACK_LOW), a right side of the graph illustrated in FIG. 10B indicates a case in which a high temperature is selected using a high control voltage (TEMP_F/BACK_HIGH), and a space between the low temperature and the high temperature indicates a case in which an intermediate temperature is an intermediate control voltage between the low control voltage and the high control voltage. In FIG. 10B, with respect to the temperature control door, when the number of passengers (N) increases, the correction unit 300 may subtract a weight (W) from a target control value (TD_2) of the temperature control door to obtain a target correction control value (TDC_2) of the temperature control door, such that temperature may be lowered.

Referring to FIG. 10C, a left side of the graph illustrated in FIG. 10C indicates a case in which maximum cooling and a high air volume are selected using a maximum cooling control voltage (V_BLOWER_MAX_COOL) and a high blowing air volume control voltage (BLOWER VOLTAGE), and a right side of the graph indicates a case in which maximum heating and a high air volume are selected using a maximum heating control voltage (V_BLOWER_MAX_HOT) and a high blowing air volume control voltage (BLOWER VOLTAGE). In FIG. 10C, with respect to the blower control door, when the number of passengers (N) increases, the correction unit 300 may subtract a weight (W) to a target control value (TD_3) of the blower control door to obtain a target correction control value (TDC_3) of the blower control door, when currently in a cooling state, such that an amount of cooling air may increase.

FIG. 11 is an example diagram of a control unit.

Referring to FIG. 11, the control unit 400 may include an operation mode memory 410 and a controller 420.

With respect to one target air conditioning device, the operation mode memory 410 may store different automatic mode target correction control values (TDC1, TDC2, . . . ) for detected temperatures (Temp1, Temp2, . . . ) for an automatic mode (for example, ST4=“H”) of the air conditioning system 60, and may store a preset manual mode target control value (TD−M) for a manual mode (for example, ST4=“L”) of the air conditioning system 60.

When one target air conditioning device of the air conditioning system 60 is in an automatic mode, the controller 420 may control the target air conditioning device of the air conditioning system 60 using the different automatic mode target correction control values (TDC1, TDC2, . . . ) for the detected temperatures (Temp1, Temp2, . . . ), stored in the memory 410.

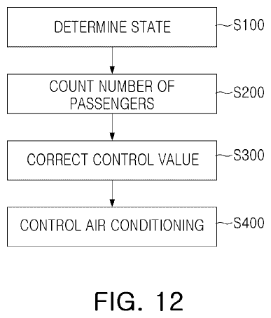

Subsequently, an air conditioning control method will be described with reference to FIGS. 12 to 17. In the present disclosure, a description of the air conditioning control method and a description of an air conditioning control device may complement each other or may be applied in common, unless the descriptions are mutually exclusive. Accordingly, a repeated description may be omitted. Main processes of the air conditioning control method will be described below.

FIG. 12 is a flowchart of an air conditioning control method.

Referring to FIG. 12, the air conditioning control method may be implemented by the air conditioning control apparatus 50 illustrated in FIGS. 1 to 11, and the air conditioning control method may include a state determination operation (S100), a passenger counting operation (S200), a control value correction operation (S300), and an air conditioning control operation (S400).

In the state determination operation (S100), the air conditioning control apparatus 50 (see FIG. 1) may determine, based on an operating state, a speed, and a door state of a transportation means 5, equipped with a LiDAR device 40 and an air conditioning system 60, and an operation mode of the air conditioning system 60, whether a passenger counting condition is satisfied.

In the passenger counting operation (S200), the air conditioning control apparatus 50 (see FIG. 1) may determine, based on LiDAR information (RDI) received from the LiDAR device 40, boarding and alighting of a person with respect to the transportation means 5, may count the number of passengers (N), and may output a count value (CN), when the passenger counting condition is satisfied

In the control value correction operation (S300), the air conditioning control apparatus 50 (see FIG. 1) may correct, based on the count value (CN), a target control value (TD) in response to the number of passengers (N), and may output a target correction control value (TDC).

In the air conditioning control operation (S400), the air conditioning control apparatus 50 (see FIG. 1) may control, based on the target correction control value (TDC), the air conditioning system 60. With respect to the description of FIG. 12, the description of FIG. 2 may be referred to.

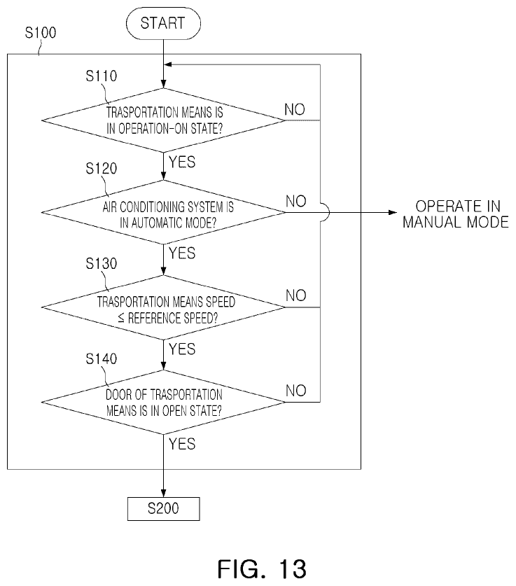

FIG. 13 is an example diagram of a state determination operation.

Referring to FIG. 13, in the state determination operation (S100), the air conditioning control apparatus 50 (see FIG. 1) may determine that the passenger counting condition is satisfied, when a condition (S110) in which the transportation means 5 is in an operation-on state, a condition (S120) in which the air conditioning system 60 is in an automatic mode, a condition (S130) in which a speed of the transportation means 5 is less than or equal to a reference speed, and a condition (S140) in which a door of the transportation means 5 is in an open state are all met.

For example, in the state determination operation (S100), the air conditioning control apparatus 50 (see FIG. 1) may output a trigger signal (ST) for starting an operation of counting the number of passengers, when Condition 1 in which the transportation means 5 is in an operation-on state, Condition 2 in which a speed of the transportation means 5 is less than or equal to a reference speed, Condition 3 in which a door of the transportation means 5 is in an open state, and Condition 4 in which the air conditioning system 60 is in an automatic mode are all met. With respect to the description of FIG. 13, the description of FIG. 3 may be referred to.

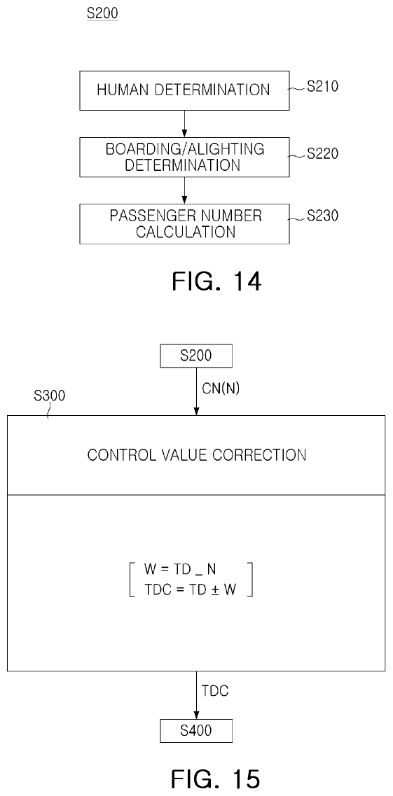

FIG. 14 is an example diagram of a passenger counting operation.

Referring to FIG. 14, the passenger counting operation (S200) may include a human determination operation (S210), a boarding/alighting determination operation (S220), and a passenger number calculation operation (S230).

In the human determination operation (S210), the air conditioning control apparatus 50 (see FIG. 1) may determine, based on the LiDAR information (RDI), whether an object, entering and exiting a preset range (SA) of the transportation means 5, is a human.

In the boarding/alighting determination operation (S220), when the object, entering and exiting a preset range (SA) of the transportation means 5, is a human, the air conditioning control apparatus 50 (see FIG. 1) may recognize boarding when a person, entering a preset range of the transportation means 5, moves closer to the transportation means 5, and may recognize alighting when a person, exiting the preset range of the transportation means 5, moves away from the transportation means 5.

In the passenger number calculation operation (S230), the air conditioning control apparatus 50 (see FIG. 1) may increase the number of passengers when the air conditioning control apparatus 50 recognizes boarding in the boarding/alighting determination operation (S220), and may decrease the number of passengers when the air conditioning control apparatus 50 recognizes alighting in the boarding/alighting determination operation (S220). With respect to the description of FIG. 14, the description of FIG. 4 may be referred to.

FIG. 15 is an example diagram of a control value correction operation using a weight.

Referring to FIG. 15, in the control value correction operation (S300), the air conditioning control apparatus 50 (see FIG. 1) may calculate a weight (W) using the number of passengers (N) based on the count value (CN) and the target control value (TD), and may correct the target control value (TD) to generate the target correction control value (TDC). With respect to the description of FIG. 15, the description of FIG. 6 may be referred to.

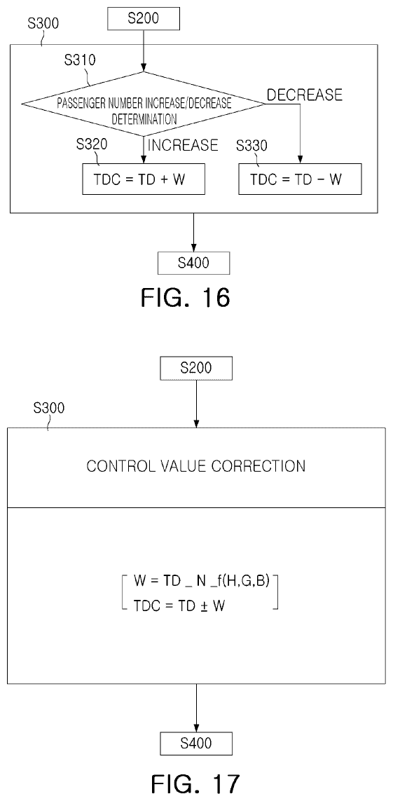

FIG. 16 is an example diagram of a control value correction operation in which a weight is applied differently in response to an increase or decrease of the number of passengers.

Referring to FIG. 16, the control value correction operation (S300) may include a passenger number increase/decrease determination operation (S310), a first correction operation (S320), and a second correction operation (S330).

In the passenger number increase/decrease determination operation (S310), the air conditioning control apparatus 50 (see FIG. 1) may determine an increase or decrease in the number of passengers.

In the first correction operation (S320), the air conditioning control apparatus 50 (see FIG. 1) may apply, in response to an increase in the number of passengers, a positive weight (+W) to the target control value (TD) to calculate the target correction control value (TDC).

In the second correction operation (S330), the air conditioning control apparatus 50 (see FIG. 1) may apply, in response to a decrease in the number of passengers, a negative weight (−W) to the target control value (TD) to calculate the target correction control value (TDC). With respect to the description of FIG. 16, the description of FIG. 7 may be referred to.

FIG. 17 is an example diagram of a control value correction operation using additional information.

Referring to FIG. 17, in the control value correction operation (S300), when the target control value (TD) is corrected, the air conditioning control apparatus 50 (see FIG. 1) may reflect, in the weight (W), at least one of pieces of additional information (for example, a height (H), gender (G), and physique information (B)). With respect to the description of FIG. 17, the description of FIG. 8 may be referred to.

Referring to FIGS. 9A and 9B, in the control value correction operation (S300), the air conditioning control apparatus 50 (see FIG. 1) may determine, in response to an increase or decrease in the number of passengers (N), the weight (W=TD_K) at an application ratio according to a preset correction function, and the correction function may be at least one of a linear function (f1), illustrated in FIG. 9A, and nonlinear functions (f2 and f3), illustrated in FIG. 9B.

In addition, the correction function of the control value correction operation (S300) may be applied up to a preset upper limit number of passengers (N_limit). When the number of passengers (N) is greater than the upper limit number of people (N_limit), a weight, corresponding to the upper limit number of passengers (N_limit), may be maintained.

Referring to FIGS. 10A, 10B, and 10C, in the control value correction operation (S300), with respect to target air conditioning devices among air preset conditioning devices included in the air conditioning system 60, the air conditioning control apparatus 50 (see FIG. 1) may calculate target correction control values (TDC−1, TD−2, and TD−3) for the target air conditioning devices by applying, in response to an operating state of each of the target air conditioning devices, the weight (W) differently to different target control values (TD1, TD2, and TD3) for the target air conditioning devices.

In the control value correction operation, when the transportation means is in an operation-off condition, the air conditioning control apparatus 50 (see FIG. 1) may control termination of the air conditioning system by initializing a weight changed in response to a change in the number of passengers.

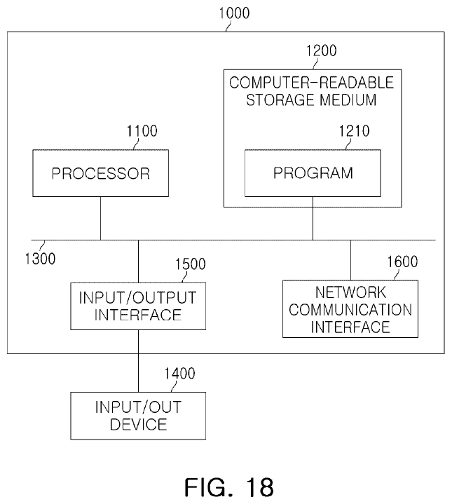

FIG. 18 is a block diagram illustrating a computing device 1000 capable of fully or partially implementing an apparatus and method for controlling air conditioning.

As illustrated in FIG. 18, the computing device 1000 may include at least one processor 1100, a computer-readable storage medium 1200, and a communication bus 1300.

The processor 1100 may cause the computing device 1000 to operate. For example, the processor 1100 may execute one or more programs stored in the computer-readable storage medium 1200. The one or more programs may include one or more computer-executable instructions. When executed by the processor 1100, the one or more computer-executable instructions may be configured to cause the computing device 1000 to perform operations.

The computer-readable storage medium 1200 may be configured to store the computer-executable instruction or program code, program data, and/or other suitable forms of information. A program 1210, stored in the computer-readable storage medium 1200, may include a set of instructions executable by the processor 1100. In an example implementation, the computer-readable storage medium 1200 may be a memory (volatile memory such as a random access memory, non-volatile memory, or any suitable combination thereof), one or more magnetic disk storage devices, optical disk storage devices, flash memory devices, other types of storage media that are accessible by the computing device 1000 and are capable of storing desired information, or any suitable combination thereof.

The communication bus 1300 may interconnect various other components of the computing device 1000, including the processor 1100 and the computer-readable storage medium 1200.

The computing device 1000 may also include one or more input/output interfaces 1500 providing an interface for one or more input/output devices 1400, and one or more network communication interfaces 1600. The input/output interface 1500 and the network communication interface 1600 may be connected to the communication bus 1300. The network may be one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), or long-term evolution (LTE), or another cellular network.

The input/output device 1400 may be connected to other components of the computing device 1000 through the input/output interface 1500. The exemplary input/output device 1400 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The exemplary input/output device 1400 may be included in the computing device 1000 as a component included in the computing device 1000, or may be connected to the computing device 1000 as a device distinct from the computing device 1000.

Example implementations of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the example implementations, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

While example implementations have been shown and described above, it will be apparent to those skilled in the art that modifications and variations could be made without departing from the scope of the present disclosure as defined by the appended claims.

What is claimed is:

1. An apparatus configured to control an air conditioning system of a vehicle using a light detection and ranging (LiDAR) device of the vehicle, the apparatus comprising one or more processors configured to:
determine whether a passenger counting condition is satisfied based on an operating state of the vehicle, a speed of the vehicle, a door state of the vehicle, and an operation mode of the air conditioning system of the vehicle;
based on determining that the passenger counting condition is satisfied, determine whether one or more people board the vehicle or alight from the vehicle based on LiDAR information received from the LiDAR device to thereby count a number of passengers in the vehicle;
based on a count value of the number of the passengers in the vehicle, determine a target control value corresponding to the number of the passengers and output a target correction control value; and
control the air conditioning system based on the target correction control value.

2. The apparatus of claim 1, wherein the one or more processors are configured to determine that the passenger counting condition is satisfied based on (i) the vehicle being in an operation-on state, (ii) the air conditioning system being in an automatic mode, (iii) the speed of the vehicle being less than or equal to a reference speed, and (iv) a door of the vehicle being in an open state.

3. The apparatus of claim 1, wherein the one or more processors are configured to:
determine, based on the LiDAR information, whether an object entering and exiting a preset range of the vehicle is a human;
recognize a boarding of a person onto the vehicle, based on determining that the object is a human, enters the preset range of the vehicle, and moves toward the vehicle,
recognize an alighting of a person from the vehicle based on determining that the object is human, exits the preset range of the vehicle, and moves away from the vehicle;
increase the number of the passengers based on recognizing the boarding of the person; and
decrease the number of the passengers based on recognizing the alighting of the person.

4. The apparatus of claim 3, further comprising a control value memory configured to store predetermined target control values,
wherein the one or more processors are configured to:
calculate a weight of the number of the passengers based on the count value and the predetermined target control values,
correct the target control value based on the weight, and
output the target correction control value corrected based on the weight.

5. The apparatus of claim 4, wherein the one or more processors are configured to:
determine an increase of the number of the passengers or a decrease of the number of the passengers;
based on determining the increase of the number of the passengers, calculate the target correction control value by applying a positive (+) weight to the target control value; and
based on determining the decrease of the number of the passengers, calculate the target correction control value by applying a negative (−) weight to the target control value.

6. The apparatus of claim 4, wherein the one or more processors are configured to, based on correcting the target control value, reflect, in the weight, at least one of pieces of additional information that is included in the LiDAR information on a person entering and exiting the preset range.

7. The apparatus of claim 4, wherein the one or more processors are configured to, based on an increase of the number of the passengers or a decrease of the number of the passengers, determine an application ratio of the weight according to a preset correction function, and
wherein the preset correction function comprises at least one of a linear function or a nonlinear function.

8. The apparatus of claim 7, wherein the one or more processors are configured to:
apply the application ratio of the weight according to the preset correction function based on the number of the passengers in the vehicle being less than or equal to a preset upper limit number of passengers; and
maintain an upper limit weight corresponding to the upper limit number of passengers based on the number of the passengers in the vehicle being greater than the upper limit number of passengers.

9. The apparatus of claim 4, wherein the air conditioning system includes air conditioning devices including preset target air conditioning devices,
wherein the one or more processors are configured to:
calculate target correction control values for the target air conditioning devices by applying different weights to different target control values for the target air conditioning devices based on an operating state of each of the target air conditioning devices.

10. The apparatus of claim 2, further comprising an operation mode memory configured to store (i) an automatic mode target correction control value for each detected temperature for the automatic mode of the air conditioning system, and (ii) a preset manual mode target control value for a manual mode of the air conditioning system,
wherein the one or more processors are configured to, based on the air conditioning system operating in the automatic mode, control the air conditioning system using a detected temperature in the vehicle and the automatic mode target correction control value.

11. A method for controlling an air conditioning system of a vehicle using a light detection and ranging (LiDAR) device, the method comprising:
determining whether a passenger counting condition is satisfied based on an operating state of the vehicle, a speed of the vehicle, a door state of the vehicle, and an operation mode of the air conditioning system;
based on determining that the passenger counting condition is satisfied, determining whether one or more people board the vehicle or alight from the vehicle based on LiDAR information received from the LiDAR device to thereby count a number of passengers in the vehicle;
based on a count value of the number of the passengers in the vehicle, determining a target control value corresponding to the number of the passengers and output a target correction control value; and
controlling the air conditioning system based on the target correction control value.

12. The method of claim 11, further comprising:
determining that the passenger counting condition is satisfied based on (i) the vehicle being in an operation-on state, (ii) the air conditioning system being in an automatic mode, (iii) the speed of the vehicle being less than or equal to a reference speed, and (iv) a door of the vehicle being in an open state.

13. The method of claim 11, further comprising:
determining, based on the LiDAR information, whether an object entering and exiting a preset range of the vehicle is a human;
recognizing a boarding of a person onto the vehicle, based on determining that the object is a human, enters the preset range of the vehicle, and moves toward the vehicle,
recognizing an alighting of a person from the vehicle based on determining that the object is human, exits the preset range of the vehicle, and moves away from the vehicle;
increasing the number of the passengers based on recognizing the boarding of the person; and
decreasing the number of the passengers based on recognizing the alighting of the person.

14. The method of claim 13, wherein determining the target control value comprises:
calculating a weight corresponding to the number of the passengers based on the count value;
correcting the target control value based on the weight; and
outputting the target correction control value corrected based on the weight.

15. The method of claim 11, further comprising:
determining an increase of the number of the passengers or a decrease of the number of the passengers;
based on determining the increase of the number of the passengers, calculating the target correction control value by applying a positive (+) weight to the target control value; and
based on determining the decrease of the number of the passengers, calculating the target correction control value by applying a negative (−) weight to the target control value.

16. The method of claim 14, wherein determining the target control value comprises:
based on correcting the target control value, reflecting, in the weight, at least one of pieces of additional information that is included in the LiDAR information on a person entering and exiting the preset range.

17. The method of claim 14, wherein determining the target control value comprises, based on an increase of the number of the passengers or a decrease of the number of the passengers, determining an application ratio of the weight according to a preset correction function, and
wherein the preset correction function comprises at least one of a linear function or a nonlinear function.

18. The method of claim 17, further comprising:
applying the application ratio of the weight according to the preset correction function based on the number of the passengers in the vehicle being less than or equal to a preset upper limit number of passengers; and
maintaining an upper limit weight corresponding to the upper limit number of passengers based on the number of the passengers in the vehicle being greater than the upper limit number of passengers.

19. The method of claim 14, wherein the air conditioning system includes air conditioning devices including preset target air conditioning devices,
wherein the method further comprises:
calculating target correction control values for the target air conditioning devices by applying different weights to different target control values for the target air conditioning devices based on an operating state of each of the target air conditioning devices.

20. The method of claim 11, further comprising:
terminating operation of the air conditioning system by initializing a weight that is changed in response to a change of the number of the passengers.
